(19) United States
(12) Patent Application Publication
(10) Pub. No.: US 2010/0322827 A1
(43) Pub. Date: Dec. 23, 2010

(54) METHOD AND DEVICE FOR CLEANING THE WASTE GASES OF A PROCESSING SYSTEM

(75) Inventor: Alexander Gschwandtner, Munchen (DE)

Correspondence Address: DAVIS & BUJOLD, P.L.L.C., 112 PLEASANT STREET, CONCORD, NH, 03301, US

(73) Assignees: CS CLEAN SYSTEMS AG, Ismaning (DE); R3T GMBH RAPID REACTIVE RADICALS TECHNOLGY, Taufkirchen (DE)

(21) Appl. No.: 12/867,594

(22) PCT Filed: Feb. 10, 2009
(86) PCT No.: PCT/DE2009/000185

§ 371 Date: Aug. 30, 2010

(30) Foreign Application Priority Data
Feb. 18, 2008 (DE) 10 2008 009 624.5

(51) Int. Cl. B01D 53/34

(52) U.S. Cl. 422/175; 422/168

(57) ABSTRACT

In order to clean the waste gases from a processing system (1), in which a process using non-metal halide is carried out, the waste gas (3) is mixed with a gas (7) that prevents recombination of ionized particles formed from the non-metal fluoride. In a gas discharge chamber (25), the waste gas (3, 7) is then converted into a plasma in which the non-metal halide, present in the waste gas (3, 7), is ionized. The ionized particles, that have been saturated with the gas, prevent the recombination thereof and can then be removed from the waste gas.

This application is a National Stage completion of PCT/DE2009/000185 filed Feb. 10, 2009, which claims priority from German patent application serial no. 10 2008 009 624.5 filed Feb. 18, 2008.

### FIELD OF THE INVENTION

The semiconductor industry uses large amounts of non-metal halides for dry etching. These include in particular perfluorinated compounds, such as carbon tetrafluoride (CF₄), hexafluoroethane (C₂F₆), fluorohydrocarbons, such as trifluoromethane (CHF₃), sulfur hexafluoride (SF₆), and nitrogen trifluoride (NF₃). From these non-metal halides, ionized particles are produced in a plasma, e.g., in a chamber or similar processing system, for example fluorine radicals, that are used to etch the semiconductor substrate, such as a wafer or a photovoltaic coating.

### BACKGROUND OF THE INVENTION

The non-metal fluorides are extremely inert. For this reason, only a small fraction of the non-metal halide that is fed into the processing system is split into ionized particles, while by far the largest fraction exits the processing system unchanged. Due to their inertness, the non-metal fluorides are typically not captured by the waste gas cleaning systems used in the semiconductor industry and are thus released into the atmosphere.

However, perfluorinated compounds and similar non-metal fluorides are characterized by a high climate impact, i.e., their so-called GWP (Greenhouse Warming Potential). This is particularly true for sulfur hexafluoride, which has an extremely high GWP. Moreover, several of these non-metal halides are toxic, for example, nitrogen trifluoride.

A device is known from DE 10 2006 006 289 A1, with which, using a microwave generator in a gas discharge chamber to which a non-metal fluoride has been added via a line, a plasma is produced in order to generate an ionized etching gas. The gas feed line has only a small diameter to prevent through-ignition.

### SUMMARY OF THE INVENTION

It is the object of the invention to provide an effective method and an effective device for removing non-metal halides from waste gases of a processing system, in which a procedure using a non-metal halide is carried out.

Only a fraction of the non-metal fluoride is consumed in the processing system. This means that a waste gas, having a high percentage of non-metal halides, exits the processing system. The waste gas exiting the processing system is mixed, according to the invention, with a gas that prevents the recombination of the ionized particles formed from the non-metal halide. The waste gas is subsequently converted to a plasma, in which the non-metal halide present therein is completely ionized. The ionized particles are saturated with the gas preventing their recombination and can then be removed from the waste gas, for example by absorption using an absorbing agent.

The plasma, formed by converting the waste gas which has been mixed with the gas preventing the recombination of the ionized particles, is preferably produced using a microwave generator. These can be generators that operate with the customary, licensed frequencies of 915 MHz, 2.45 GHz, and 5.8 GHz and produce between 300 W and 10 kW or more of power.

The non-metal halide that is used in the processing system for etching a semiconductor substrate, and a large fraction of which may then be present unconsumed in the waste gas of the processing system, can be, for example, a fluorocarbon, such as CF₄ or C₂F₆, a fluorohydrocarbon, such as CHF₃ or SF₆ and also NF₃, or another gaseous climate-impacting and/or toxic non-metal halide.

The gas that is added to the waste gas, to prevent the recombination of ionized particles formed by the plasma, may contain oxygen, hydrogen, chlorine, water, or another compound that can be reacted with the ionized particles formed from the non-metal fluoride. Ionized particles also include excited particles, in particular also radicals. Particularly suitable compounds that can be reacted with the non-metal fluoride are radical scavengers.

The device for carrying out the method according to the invention has a waste gas line, which feeds the waste gas containing the non-metal halide discharged from the processing system to a gas discharge chamber, in which a plasma is produced with the microwave generator. A feed line is additionally provided, which mixes the waste gas with the gas that prevents the recombination of ionized particles formed from the non-metal halide. This feed line is preferably connected to the waste gas line in such a way that the waste gas will be mixed with the gas preventing the recombination of the ionized particles, prior to entering the gas discharge chamber.

The gas discharge chamber is preferably formed by a channel, through which passes the waste gas to be cleaned that is mixed with the gas preventing the recombination of ionized particle. The waste gas passing through the channel is preferably vacuumed off with a pump that simultaneously produces the negative pressure of 0.1 to 10 mbar, for example, in the gas discharge chamber that is necessary for plasma formation.

The channel is preferably formed by a tube consisting of a dielectric material, in particular ceramic, and preferably aluminum oxide. The inside diameter of the tube can be 10 to 100 mm, for example.

The tube is arranged in a heatsink or similar cooled housing. The temperature of the plasma in the tube can be 1000° C. and higher. On the other hand, also flowing through the tube are compounds formed in the production system that may condense and precipitate in the tube that is cooled in the heatsink.

For this reason, a gap is preferably provided between the tube and the heatsink, such that the temperature of the tube can be adjusted to an advantageous value, for example in the range of from 100 to 500° C.

For this purpose, the gap between the tube and the heatsink can be between five hundredths and several millimeters, for example. Cooling that can be adjusted over the entire surface of the tube minimizes condensation or precipitation of compounds produced in a production system on the inside wall of the tube and also chemical attacks on the tube.

Heat generated by the plasma is conducted via the gap to the heatsink and further to the coolant in the heatsink, making defined cooling of the tube possible. Heat conduction between the tube and the heatsink is carried out via heat transport through molecules that are located in the gap, wherein the distance of the mean free path of the molecules is approximately of the same size or smaller than the width of the gap, making very effective and defined cooling possible.

In the cooling jacket, a bearing is preferably provided for the tube for the formation of the gap. The bearing preferably has rings in which the tube is arranged. For this purpose, metallic rings in particular are used.

Because these rings have only a small contact area, cooling over the entire surface of the tube is essentially guaranteed. This avoids “cold spots,” which are normally the cause when a ceramic tube breaks. In addition, when the tube should be exchanged, it needs to be merely pulled from the bearing rings, after which a new tube can be pushed into the bearing rings.

The microwave is directed into the tube by a microwave generator, preferably using a linear Hertzian oscillator. The oscillator is preferably arranged in a coupler consisting of a dielectric material, which has a concave depression designed in such a way that the entire surface of the coupler abuts against the tube. In this case, the coupler also preferably consists of ceramic, for example aluminum oxide. Advantageously, the dielectric constants of the tube and the coupler are similar or the same in order to minimize or avoid reflections of the microwave at the contact surface of both bodies.

The linear Hertzian oscillator is preferably arranged in the coupler in such a way that the electromagnetic energy is coupled into the plasma, via the coupler, perpendicular to the axis of the tube.

Dimensions and placement of the linear Hertzian oscillator in the coupler are preferably selected in such a way that the energy of the microwave is introduced, as evenly as possible, into the coupler and from there into the tube. This is made possible in that the length of the Hertzian oscillator is λ/2 or a multiple thereof. This means that at a wavelength λ of about 4 cm in a coupler made of ceramic, for example aluminum oxide, the length of the oscillator is preferably 2 cm or a multiple thereof.

At the same time, the Hertzian oscillator is positioned in the center of the coupler relative to the axis of the coupler in order to assure that the electromagnetic wave radiates, as uniformly as possible, at both ends of the oscillator, causing the energy to be coupled, as uniformly as possible, to produce a uniform plasma zone in the tube.

It must be particularly emphasized that the waves propagating from the ends of the oscillator are phase-shifted by 180°, causing the waves to cancel each other out in the plane of symmetry of the oscillator and thus preventing a “hot spot” from forming on the tube.

The linear Hertzian oscillator is preferably inserted from the side into a coupler formed from a block, cylinder, or similar solid body. The microwave can now propagate in the dielectric of the coupler and further, via the tube, in the gas discharge chamber within the tube where it is absorbed, and where it is limited by two cylindrical metallic waveguides that are positioned perpendicular to one another and that simultaneously serve as a heatsink.

The diameter of the cylindrical waveguide that surrounds the dielectric at the coupling point of the microwave and further along the gas discharge chamber and the dielectric enclosing the chamber is selected in such a way that it is greater than the cutoff wavelength that is possible for the propagation of the electromagnetic wave in at least one basic mode. The field configuration of the electromagnetic waves, in cylindrical waveguides, is best represented by cylindrical coordinates. In cylindrical coordinates, solving the wave equation, yields Bessel functions. By choosing an appropriate waveguide diameter, it is possible to produce an advantageous number of modes of the electromagnetic wave.

The distance of the oscillator from the tube corresponds to at least approximately the wavelength of the microwave in the dielectric material of the coupler, i.e., approx. 4 cm or more in a coupler made of ceramic.

An oscillating circuit is in fact formed, in which the Hertzian oscillator represents inductance and capacitance, and the plasma in the tube, an ohmic load, that may fluctuate greatly. When inductance, capacitance, and ohmic load are in close vicinity, off-resonance of the oscillating circuit may occur due to the fluctuations of the ohmic load, the result of which is that the microwave will not be completely coupled into the oscillator and will be partly reflected. Because of the distance between the Hertzian oscillator of the oscillating circuit and the ohmic load (plasma), which corresponds to at least the wavelength of the microwave in the coupler, a decoupling of the ohmic load with the capacitance of the oscillating circuit must be assumed. Thus, the natural frequency of the oscillating circuit is stable within narrow boundaries and remains within the fluctuations range of the magnetron frequency.

If the Hertzian oscillator is not significantly farther than one wavelength from the ohmic load, “near field approximation” applies, where retardation effects of the microwave do not yet come into play. In this case, the resonator can be described by a separation of inductive and capacitative load.

The resonator can be assigned an effective capacitance

C_{eff}=(C_{ceramic}×V_{ceramic}+Cₚₗₐₛₘₐ×Vₚₗₐₛₘₐ)/(V_{ceramic}+Vₚₗₐₛₘₐ)

The effective capacitance consists of the volumes taken up by the ceramic and the plasma chamber, multiplied by the respective specific capacitances. Due to the relative dielectric constant εᵣ≈10, the contribution of the ceramic per volume unit must be set higher by a factor of 10 than in the plasma chamber, where εᵣ≈1 can be assumed. In a first approximation, the capacitance of the ceramic can be calculated from the cross-sectional area of the ceramic coupler times the distance of the Hertzian oscillator to the plasma chamber.

In the device according to the invention, the volumes of the plasma chamber and the ceramic are of approximately equal size. However, due to the 10 times greater εᵣ of the ceramic, the contribution of the ceramic to the effective capacitance is approximately 90%.

To estimate the relative off-resonance of the resonator, the change in effective capacitance ΔC_{eff} is relevant, which may be caused by different plasma conditions (different gases, pressures, directed microwave power).

In this case, the change in capacitance is caused by shielding effects of the plasma.

Advantageously, the relative off-resonance of the resonator is smaller than the frequency fluctuation range of the magnetron, which may be ωᵣₑₛ=2.45±0.01 GHz, for example. In the present case, this means that the relative off-resonance must be less than 0.4%, such that the microwave power can be fed into the oscillating circuit without any losses.

The relative off-resonance can be described by

Δωᵣₑₛ/ωᵣₑₛ=½ΔC_{eff}

Assuming a 5% change in capacitance of the plasma chamber due to different plasma conditions, which has been experimentally verified, the influence on the relative off-resonance is 0.25%.

Advantageously, the ceramic volume (cross-section times distance to plasma chamber) is selected to be of a size such that the relative off-resonance of the oscillating circuit lies within the frequency fluctuation range of the magnetron. From the ceramic volume, a minimum distance between the Hertzian oscillator and the plasma chamber can then be determined.

### BRIEF DESCRIPTION OF THE DRAWINGS

By way of example, the invention is explained in more detail with the appended drawings. Schematically they show, in

FIG. 1, a processing system to which the waste gas cleaning device according to the invention is connected; and

FIGS. 2 and 3, respectively, a cross section and a longitudinal section through the embodiment of the waste gas cleaning device according to the invention.

### DETAILED DESCRIPTION OF THE PREFERRED EMBODIMENTS

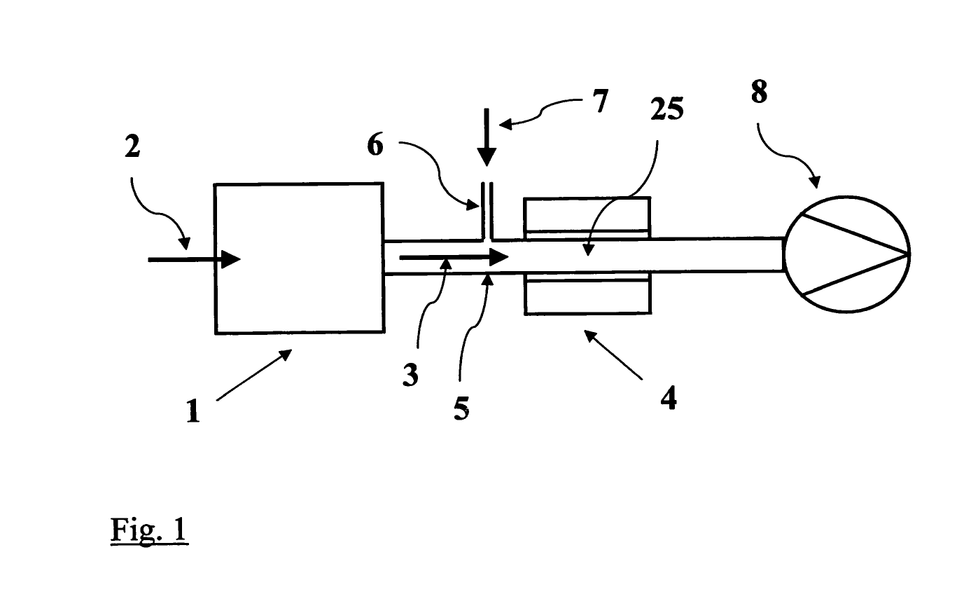

According to FIG. 1, a non-metal halide, e.g.; CF₄, is fed into a processing system 1, for example an etching chamber, according to the arrow 2, for etching a silicone semiconductor substrate. In this case, an etching process can be carried out in which a plasma is used to form excited and/or ionized particles from the non-metal halide. The plasma of the processing system 1 can be produced, for example, by using a device as per DE 10 2006 006 289 A1.

In the processing system 1, only a fraction of the non-metal halide, that is, CF₄, for example, is used up. The largest fraction of the non-metal halide thus exits the processing system 1 as a waste gas, wherein, as represented by the arrow 3, it is fed, according to the invention, into the waste gas cleaning device 4, according to the invention, which is connected with the processing system 1 via the waste gas line 5.

A feed line 6 is connected to the waste gas line 5, via which a gas is mixed to the waste gas according to the arrow 7, which is to prevent a recombination of ionized particles that form in the waste gas cleaning device from the non-metal halide. The gas 7 preventing the recombination of ionized particles may contain, e.g., oxygen, water, or another compound that can be reacted with the ionized particles formed from the non-metal fluoride.

In the waste gas cleaning device 4, the non-metal halide is ionized in a plasma in the gas discharge chamber 25, wherein the ionized particles are saturated with the gas preventing their recombination, making it possible to remove them with an absorbing agent, for example, after they exit the waste gas cleaning device 4. With the pump 8, the waste gas is vacuumed from the waste gas cleaning device 4, which simultaneously produces the negative pressure necessary for plasma formation in the waste gas cleaning device 4.

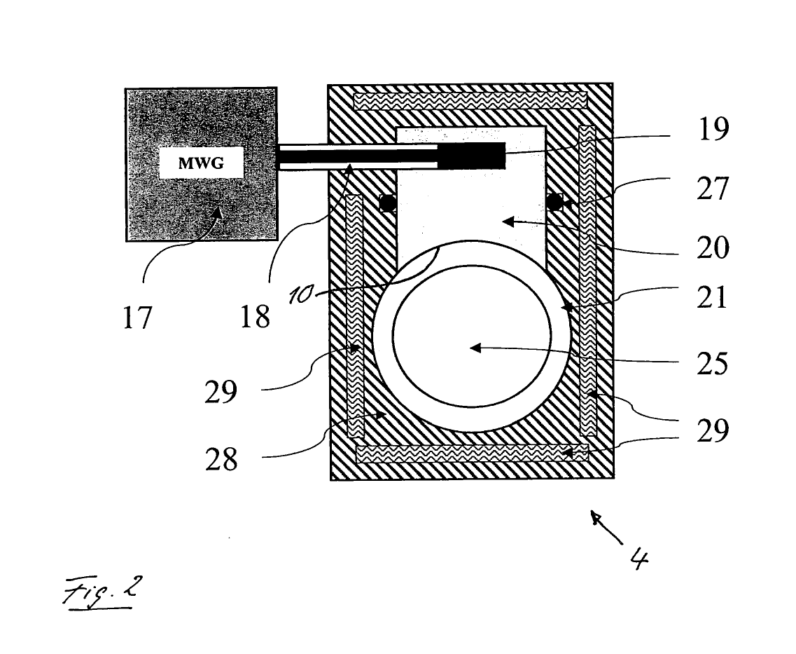

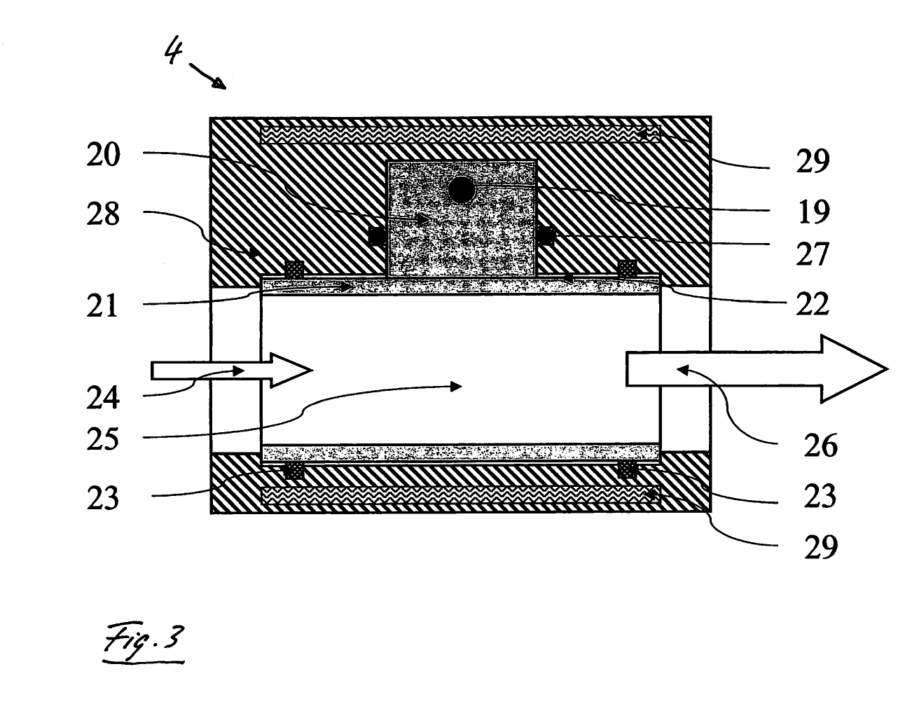

According to FIGS. 2 and 3, the waste gas cleaning device 4 has a microwave generator 17, which is connected via a coaxial conductor 18 that is designed as a coupling pin to a linear Hertzian oscillator 19. The microwave generator 17 comprises a high voltage power supply and a magnetron head, which is advantageously equipped with a so-called isolator in order to deflect the returning electromagnetic wave to a water load, where it is then absorbed.

The microwave is transferred to the oscillator 19 via the coaxial conductor 18, wherein the impedance of the coaxial conductor 18 is preferably between 50 and 75 ohm.

Via the oscillator 19, the microwave is directed into the coupler 20 that consists of ceramic, for example.

The Hertzian linear oscillator 19, designed as a coupling pin, has a fundamental oscillation of λ/2. Because the oscillator 19 is enclosed by ceramic, for example aluminum oxide, its length is approx. 2 cm at a microwave frequency of 2.45 GHz.

The microwave propagates across the dielectric of the coupler 20 and across the dielectric tube 21 in order to enter the gas discharge chamber 25, where it is absorbed by the waste gas 3, which has been previously mixed with a gas 7 preventing recombination (FIG. 1), and thereby forms a plasma. The coupler 20 and the tube 21, which are positioned perpendicular to one another, are enclosed by a metallic heatsink 28 that limits the microwave radiation and is cooled from all sides by a water jacket 29.

The distance of the oscillator 19 to the upper boundary of the gas discharge chamber 25 is about 4 cm and thus corresponds to the wavelength λ of the microwave at 2.45 GHz in aluminum oxide. This causes the oscillator 19 to become decoupled from the ohmic load in the gas discharge chamber 25.

The oscillator 19 is positioned farther in the center of the coupler 20 to assure that the electromagnetic wave radiates as uniformly as possible at both ends of the oscillator, and to produce a plasma zone in the tube 21 that is as uniform as possible.

It must be emphasized that the waves propagating from the ends of the oscillator 19 are phase-shifted by 180°, causing the waves to cancel each other out in the plane of symmetry of the oscillator 19 and thus preventing a “hot spot” from forming on the tube 21.

The tube 21 is mounted in such a way that a gap 22 of defined size, e.g., 0.05 to several millimeters, can be set between the heatsink 28 and the tube 21 in order to set a temperature of e.g., 100 to 500° C. on the inside wall of the tube 21, which is to prevent condensation and precipitation of the compounds present in the waste gas 3 (FIG. 1).

The tube 21 is advantageously mounted on metallic rings 23 whose contact areas, both with the heatsink 28 and also with the tube 21, are small in order to avoid “cold spots” on the tube 21 that is prone to cracks.

The waste gas 3 that is fed into the waste gas cleaning device 4, via the line 5 (FIG. 1), is fed via a gas inlet 24 to the gas discharge chamber 25 and is discharged via the gas outlet 26.

A vacuum seal 27, that separates the gas discharge chamber 25 from the atmosphere, is arranged between the coupler 20 and the heatsink 28.

Naturally, the tube 21 can also have a cross-section different from the circular cross-section shown in FIG. 2, it can be elliptic, prismatic, or rectangular, for example.

The coupler 20 has a concave depression 10, with which it abuts against the entire surface of the tube 21.

1-18. (canceled)

19. A device for cleaning waste gases of a processing system (1) in which a process is carried out using a non-metal halide, the processing system (1) comprising:
a waste gas line (5) for discharging the waste gas (3) from the system;
a feed line (6) being connected to the waste gas line (5), for discharging the waste gas (3), for supplying a gas (7) which prevents recombination of ionized particles formed from the non-metal halide to the waste gas (3);
a gas discharge chamber (25) formed by a tube (21), through which the waste gas (3) to be cleaned which is mixed with the gas (7) for preventing the recombination of ionized particles passes, and
a microwave generator (17) for producing a plasma in the gas discharge chamber (25);
wherein a linear Hertzian oscillator (19) is coupled to the microwave generator (17) so that microwaves from the microwave generator (17) are directed into the tube (21); and
the oscillator (19) is arranged in a coupler (20) which has a concave depression (10) designed such that an entire surface of the coupler (20) abuts against the tube (21).

20. The device according to claim 19, wherein the tube (21) and the coupler (20) comprise a dielectric material.

21. The device according to claim 20, wherein the dielectric material is ceramic.

22. The device according to claim 19, wherein the tube (21) is arranged in a heatsink (28) and a gap (22) is formed between the tube (21) and the heatsink (28).

23. The device according to claim 22, wherein a bearing is provided for the tube in the heatsink (28) for formation of the gap (22).

24. The device according to claim 23, wherein the bearing is formed by rings (23) in which the tube (21) is arranged.

25. The device according to claim 19, wherein a length of the oscillator (19) corresponds to one of one half and a multiple of one half of the wavelength (λ) of the microwaves in the dielectric material of the coupler (20).

26. The device according to claim 19, wherein a distance of the oscillator (19) from the tube (21) corresponds to at least the wavelength of the microwaves in the dielectric material of the coupler (20).

27. The device according to claim 19, wherein the gas (7) for preventing recombination of the ionized particles is at least one of oxygen, hydrogen, chlorine and water.
